(19) United States
(12) Patent Application Publication
(10) Pub. No.: US 2010/0290825 A1
(43) Pub. Date: Nov. 18, 2010

(54) IMAGE FORMING APPARATUS, SHEET DISCHARGING APPARATUS, AND SHEET DISCHARGING METHOD

(75) Inventor: Ken IGUCHI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/779,584

(22) Filed: May 13, 2010

Related U.S. Application Data
(60) Provisional application No. 61/178,365, filed on May 14, 2009.
(60) Provisional application No. 61/178,399, filed on May 14, 2009.

(51) Int. Cl. G03G 15/00; B65H 31/02; B65H 29/00

(52) U.S. Cl. 399/405; 271/207; 271/220

(57) ABSTRACT

An embodiment of an image forming apparatus includes: a sheet discharging unit provided in a space between a document reading unit and an image forming unit; a stack tray on which a sheet discharged to the sheet discharging unit is stacked; a rotating mechanism configured to lift and lower, with a front surface side of the stack tray as a fulcrum, the other end of the stack tray to incline the stack tray; and a control unit configured to control an angle of inclination of the stack tray in association with the discharge of the sheet such that the angle of inclination decreases as sheets stacked on the stack tray increase.

### CROSS-REFERENCE TO RELATED APPLICATION

This application is based upon and claims the priority of U.S. Provisional Application No. 61/178,365, filed on May 14, 2009, and U.S. Provisional Application No. 61/178,399, filed on May 14, 2009, the entire contents of which are incorporated herein by reference.

### TECHNICAL FIELD

The embodiment described herein relates to improvement of a stack tray on which sheets discharged from an image forming apparatus such as a copying machine, a printer, or a multi-function peripheral (MFP) or a sheet finishing apparatus are stacked.

### BACKGROUND

In recent years, in an image forming apparatus (e.g., a MFP), a sheet finishing apparatus is provided adjacent to the MFP in a post stage thereof in order to apply finishing to sheets subjected to image formation. The sheet finishing apparatus punches sheets sent from the MFP or staples the sheets and discharges the sheets to a stack tray. The sheet finishing apparatus is called finisher.

If the finisher is arranged on a side of the image forming apparatus, a large space is necessary. Therefore, in some example, a small finisher is arranged in a body of the image forming apparatus by utilizing a space in the image forming apparatus. However, if the finisher is arranged in the body, since mechanisms such as a document reader (ADF) and a printer are present above and below the stack tray, difficult to see sheets discharged onto the stack tray and take out the sheets from the stack tray.

### DESCRIPTION OF THE DRAWINGS

FIG. 1 is a perspective view of an image forming apparatus according to an embodiment;

FIG. 2 is a diagram of the internal structure of the image forming apparatus;

FIG. 3 is a side view of a sheet discharging unit viewed from a side direction of a main body;

FIG. 4 is a perspective view of the sheet discharging unit;

FIGS. 5A to 5D are diagrams for explaining the operation of a stack tray of the sheet discharging unit;

FIGS. 6A to 6E are diagrams for explaining another kind of operation of the stack tray;

FIG. 7 is a block diagram of a control system for the image forming apparatus and a finisher;

FIG. 8 is a flowchart for explaining sheet discharging operation shown in FIGS. 5A to 5D;

FIG. 9 is a flowchart for explaining sheet discharging operation shown in FIGS. 6A to 6E;

FIG. 10 is a perspective view of a main part of an image forming apparatus according to another embodiment;

FIG. 11 is a perspective view for explaining operation in the other embodiment;

FIG. 12 is a plan view of a lifting and lowering mechanism for the stack tray; and

FIGS. 13A and 13B are diagrams for explaining lifting and lowering operation for the stack tray.

### DETAILED DESCRIPTION

An image forming apparatus of an embodiment including: a main body incorporating an image forming unit configured to form an image on a sheet; a document reading unit arranged above the main body; a sheet discharging unit provided in a space between the document reading unit and the image forming unit; a conveying unit configured to convey the sheet to the sheet discharging unit; a stack tray on which the sheet discharged to the sheet discharging unit is stacked; a rotating mechanism configured to lift and lower, with a front surface side of the stack tray as a fulcrum, the other end of the stack tray to incline the stack tray; and a control unit configured to control an angle of inclination of the stack tray in association with the discharge of the sheet such that the angle of inclination decreases as sheets stacked on the stack tray increase.

Hereinafter, the image forming apparatus and the sheet discharging apparatus according to the embodiment will be described in detail with reference to the drawings. The same reference numerals are given to the same constituents in the respective drawings.

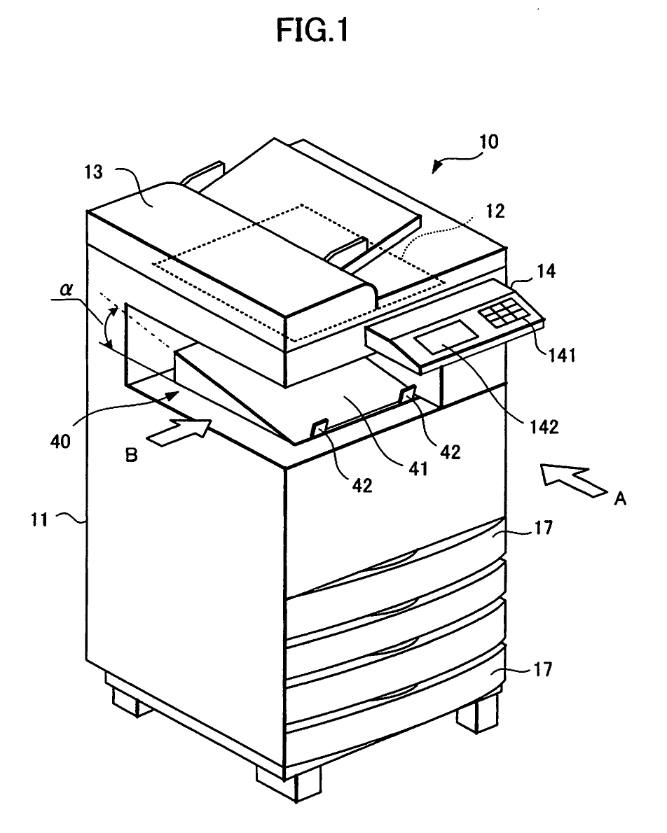

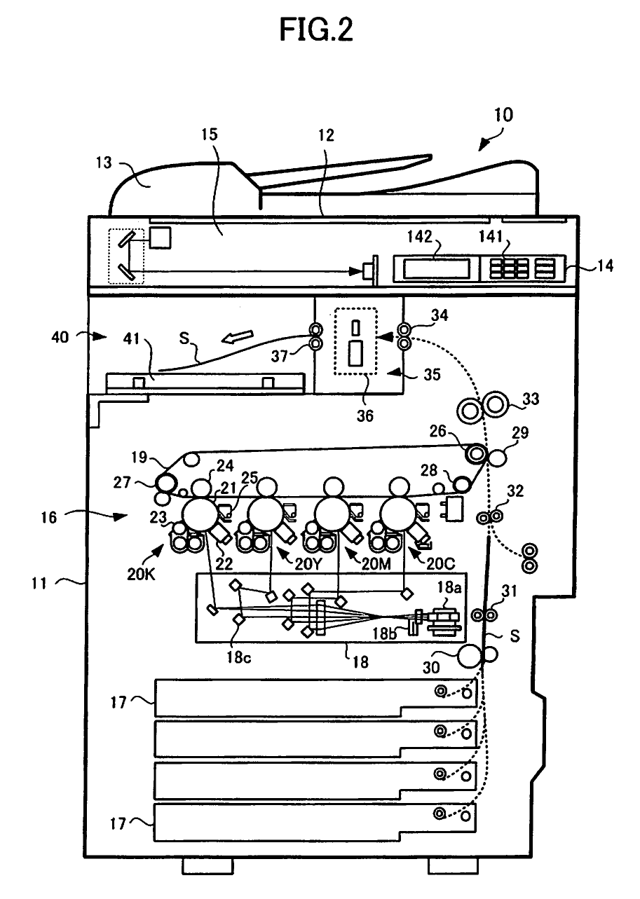

FIG. 1 is a perspective view of an image forming apparatus 10 according to an embodiment. FIG. 2 is a diagram of the internal structure of the image forming apparatus 10. In the following explanation, a MFP (Multi-Function Peripheral) as a complex machine is explained as an example of the image forming apparatus 10. However, the present invention can also be applied to other image forming apparatuses such as a printer and a copying machine.

In FIGS. 1 and 2, a document table 12 is provided in an upper part of a main body 11 of the MFP (the image forming apparatus) 10. An auto document feeder (ADF) 13 is openably and closably provided on the document table 12. An operation panel 14 is also provided in the upper part of the main body 11. The operation panel 14 includes an operation section 141 including various keys and a display section 142 of a touch panel type.

As shown in FIG. 2, a scanner unit 15 and a printer unit 16 are provided in the inside of the main body 11. Plural cassettes 17 in which sheets of various sizes are stored are provided in a lower part of the main body 11. The scanner unit 15 reads an original document sent by the ADF 13 or an original document placed on the document table 12.

The printer unit 16 configures an image forming unit, includes photoconductive drums and a laser, and processes image data read by the scanner unit 15 or image data created by a PC (Personal Computer) or the like to form an image on a sheet.

The printer unit 16 is, for example, a color laser printer of a tandem system. The printer unit 16 scans a photoconductive member with a laser beam from a laser exposure device 18 and generates an image. The laser exposure device 18 includes a polygon mirror 18a, a focusing lens system 18b, a mirror 18c and the like and irradiates a laser beam emitted from a semiconductor laser element on the photoconductive member.

The printer unit 16 includes, for example, an intermediate transfer belt 19 as a recording medium and includes, on the lower side of the intermediate transfer belt 19, image forming sections 20K, 20Y, 20M, and 20C for respective colors black (K), yellow (Y), magenta (M), and cyan (C).

The image forming sections 20K, 20Y, 20M, and 20C are arrayed in parallel to one another from upstream to downstream along the intermediate transfer belt 19 on the lower side thereof. The image forming sections 20K, 20Y, 20M, and 20C have the same configuration.

For example, the image forming section 20K has a photoconductive drum 21 as an image bearing member. An electrifying charger 22, a developing device including a developing roller 23, a primary transfer roller 24, a cleaner 25, and the like are arranged around the photoconductive drum 21 along a rotating direction thereof. A laser beam of black (K) is irradiated on an exposure position of the photoconductive drum 21 from the laser exposure device 18 and an electrostatic latent image is formed in the exposure position. The electrostatic latent image on the photoconductive drum 21 is developed by a developing roller 23 and a toner image is formed.

The photoconductive drum 21 comes into contact with the rotating intermediate transfer belt 19 and primarily transfers the toner image onto the intermediate transfer belt 19 with the primary transfer roller 24. After the photoconductive drum 21 primarily transfers the toner image onto the intermediate transfer belt 19, a residual toner on the photoconductive drum 21 is removed by the cleaner 25 or a blade to enable the next image formation.

In the same manner as a toner image forming process for black (K), toner images of yellow (Y), magenta (M), and cyan (C) are formed by the image forming units 20Y to 20C. The toner images are sequentially transferred onto the same position as the toner image of yellow (Y) on the intermediate transfer belt 19. The toner images of yellow (Y), magenta (M), and cyan (C) are multiply transferred onto the intermediate transfer belt 19 to obtain a full-color image.

The intermediate transfer belt 19 is looped around a driving roller 26 and driven rollers 27 and 28 and cyclically moves. The intermediate transfer belt 19 is opposed to and set in contact with the photoconductive drum 21. Primary transfer voltage is applied to a position of the intermediate transfer belt 19 opposed to the photoconductive drum 21 by the primary transfer roller 24. The toner image on the photoconductive drum 21 is primarily transferred onto the intermediate transfer belt 19.

A secondary transfer roller 29 is arranged to be opposed to the driving roller 26 configured to stretch and suspend the intermediate transfer belt 19. When a sheet S passes between the driving roller 26 and the secondary transfer roller 29, the secondary transfer roller 29 secondarily transfers the toner image on the intermediate transfer belt 19 onto the sheet S.

A separating roller 30 configured to extract the sheet S in the paper feeding cassettes 17, a conveying roller 31, and a registration roller 32 are provided between the paper feeding cassettes 17 and the secondary transfer roller 29. A fixing device 33 is provided downstream of the secondary transfer roller 29.

The sheet S is fed from the paper feeding cassettes 17 to the secondary transfer roller 29 in synchronization with the full-color toner image on the intermediate transfer belt 19 reaching the secondary transfer roller 29. The sheet S having the toner image secondarily transferred thereon reaches the fixing device 33 and the toner image is fixed on the sheet S.

The printer unit 16 shown in FIG. 2 is only an example. The printer unit 16 is not limited to the example shown in the figure. Various systems are possible as the printer unit 16.

A sheet finishing apparatus 35 (hereinafter referred to as finisher 35) is provided downstream of the fixing device 33. The sheet S having the image formed thereon is supplied to the finisher 35 via a conveying roller 34. The finisher 35 is provided between a lower part of the scanner unit 15 and an upper part of the printer unit 16 in the inside of the main body 11.

The finisher 35 applies finishing such as stapling or punching to the sheets S on which images are formed by the image forming apparatus 10. In an example shown in FIG. 2, the finisher 35 includes a puncher 36 and punches the sheets S.

The sheets stapled or punched by the finisher 35 are discharged to a stack tray 41, which is provided in a sheet discharging unit 40, by a conveying roller 37. The conveying roller 34 and the conveying roller 37 configure a conveying unit configured to convey the sheets S to the sheet discharging unit 40. When the finishing such as the punching or the stapling is not performed, the sheets S can also be directly conveyed to the sheet discharging unit 40. The conveying roller 37 has rollers 39 of rubber or the like attached to a pair of rotating shafts 38 as shown in FIG. 3. The conveying roller 37 holds the sheet S between the rollers 39 and conveys the sheet S according to the rotation of the rotating shafts 38.

As shown in FIG. 1, the sheet discharging unit 40 is provided in a space between the lower part of the scanner unit 15 and the upper part of the printer unit 16. The sheet discharging unit 40 includes the stack tray 41 on which sheets discharged from the finisher 35 are stacked and stoppers 42 configured to prevent the sheets stacked on the stack tray 41 from falling out of the stack tray 41. In the stack tray 41, when viewed from the front of the image forming apparatus 10 (an arrow A direction), with a front surface side of the stack tray 41 as a fulcrum, the other end on the inner side can be rotated by a predetermined angle of inclination (a). The angle of inclination decreases to be closer to a level as the sheets stacked on the stack tray 41 increase. Therefore, possible to check, from the front, the sheets discharged to the stack tray 41 and easily take out the sheets from the stack tray 41.

The configuration of the sheet discharging unit 40 is explained in detail below.

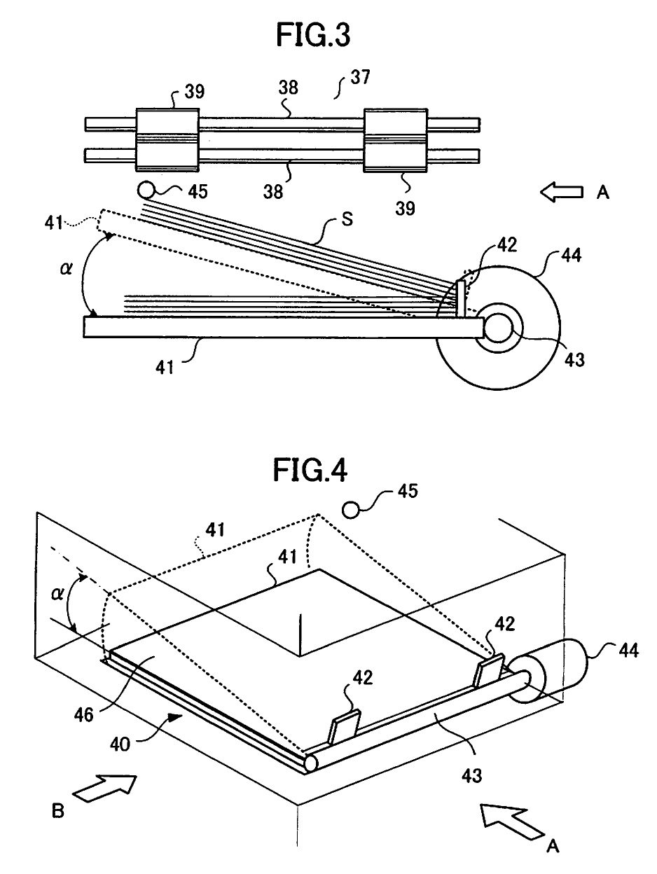

FIG. 3 is a side view of the sheet discharging unit 40 viewed from a side direction of the main body 11 (an arrow B direction in FIG. 1). FIG. 4 is a perspective view of the sheet discharging unit 40.

The sheet discharging unit 40 is provided downstream of the finisher 35. The sheet S conveyed from the conveying roller 37 is discharged onto the stack tray 41. One end on the front surface side of the stack tray 41 viewed from the front (the A direction) is supported by a columnar supporting shaft 43. The other end of the stack tray 41 can be inclined by the predetermined angle (α) with the supporting shaft 43 as a fulcrum. The supporting shaft extends in a sheet discharging direction. The supporting shaft 43 is rotated by a motor 44 to rotate the stack tray 41. The supporting shaft 43 and the motor 44 configure a rotating mechanism for the stack tray 41.

In an example shown in FIGS. 3 and 4, the supporting shaft 43 is directly rotated by the motor 44. However, also possible to provide a transmission mechanism such as a gear or a belt between the motor 44 and the supporting shaft 43 and transmit the rotation force of the motor 44 to the supporting shaft 43 via the transmission mechanism to rotate the supporting shaft 43.

In FIGS. 3 and 4, a state in which the stack tray 41 is rotated (inclined) by the motor 44 is indicated by a dotted line. A sensor 45 is attached in a lower part of the conveying roller 37. The sensor 45 is located in a position higher than the surface of the stack tray 41 when the stack tray 41 is in a level state. The sensor 45 detects that the top surface of the sheets S stacked on the stack tray 41 reaches the position of the sensor 45 or the empty stack tray 41 rotates to reach the position of the sensor 45. The sensor 45 controls the driving of the motor 44. The driving control for the motor 44 is explained later.

When the stack tray 41 is inclined and sheets S are stacked thereon, the sheets S hit against the stoppers 42 provided on the front surface side to be aligned. A cover 46 is provided on a side of the stack tray 41 viewed from the arrow B direction to prevent a finger from being caught. The cover 46 is integrally formed with the stack tray 41 and set in the main body 11. In FIG. 3, for convenience of illustration, the cover 46 is omitted.

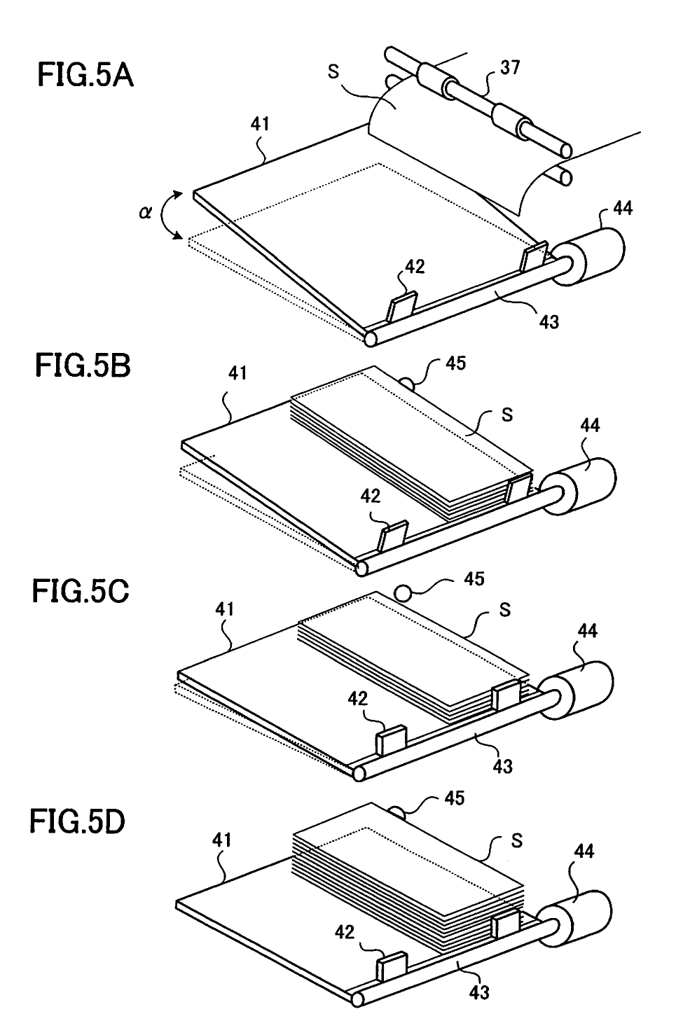

FIGS. 5A to 5D are diagrams for explaining the operation of the stack tray 41. For convenience of illustration, the cover 46 is omitted. As shown in FIG. 5A, in an initial state in which the sheet S is discharged to the sheet discharging unit 40 by the conveying roller 37, the other end of the stack tray 41 rises to the position of the sensor 45 (an angle α) and waits for the sheet S in an inclined state.

When the sheets S are sequentially discharged and stacked on the stack tray 41, as shown in FIGS. 5B and 5C, the stack tray 41 rotates in a direction in which the angle of inclination gradually decreased. The top surface of the stacked sheets S does not exceeds the position of the sensor 45.

When the sheets S are further discharged and, as shown in FIG. 5D, the other end of the stack tray 41 falls and lies level and the top surface of the stacked sheets S reaches the position of the sensor 45, the image forming apparatus 10 displays, on the display section 142, an indication that the stack tray 41 is full to warn a user to that effect and urges the user to take out the sheets.

Alternatively, in the initial state in which a print job is started in the image forming apparatus 10 and the sheet S is discharged to the sheet discharging unit 40, the stack tray 41 may fall and stay on standby in a level state. When the sheet S is discharged in the initial state, the stack tray 41 rotates to the position of the sensor 45 and receives the sheet. The stack tray 41 rotates in the direction in which the angle of inclination decreases as the sheets S are stacked. When the top surface of the stacked sheets S reaches the position of the sensor 45, the image forming apparatus 10 displays, on the display section 142, an indication that the stack tray 41 is full to warn the user to that effect.

In both the cases, when the sheet S is discharged to the sheet discharging unit 40, the stack tray 41 is inclined such that the front side thereof viewed from the user is low and the inner side thereof is high. Therefore, the user can easily recognize the discharge of the sheet S and easily take out the sheet S.

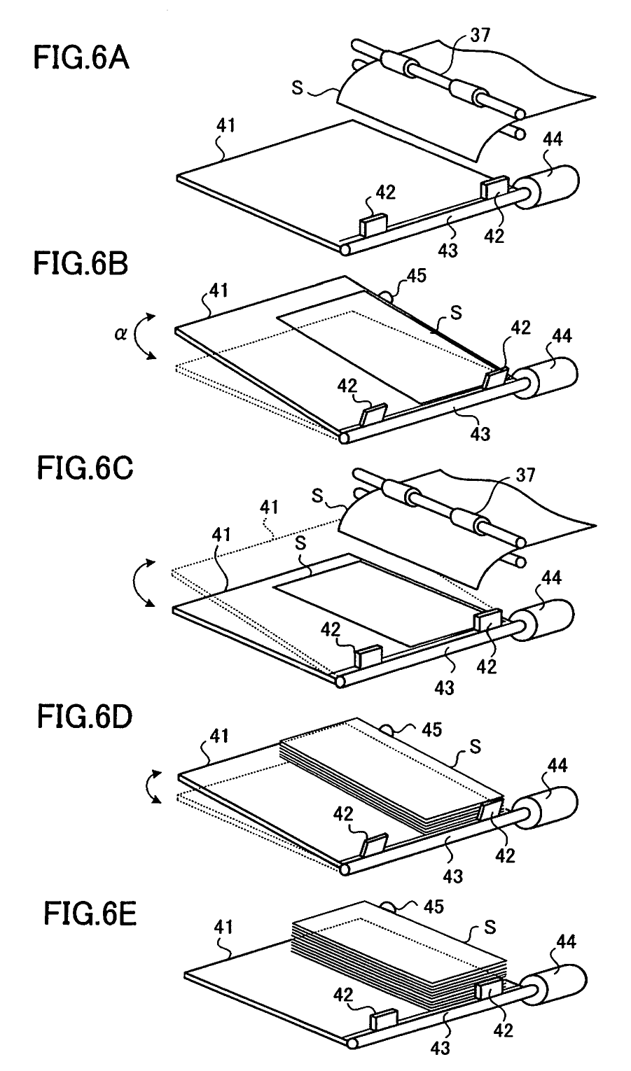

FIGS. 6A to 6E are diagrams for explaining another kind of operation of the stack tray 41. For convenience of illustration, the cover 46 is omitted. In the operation shown in FIGS. 6A to 6E, alignability of the sheets S can be further improved when the sheets S are discharged. Specifically, as shown in FIG. 6A, in the initial state in which the sheet S is discharged to the sheet discharging unit 40 by the conveying roller 37, the stack tray 41 falls and is in a level state. When the sheet S is discharged, as shown in FIG. 6B, the other end of the stack tray 41 rises to the position of the sensor 45 (the angle α). The sheet S slides on the upper surface of the inclined stack tray 41 and hits against the stoppers 42.

Subsequently, as shown in FIG. 6C, the stack tray 41 returns to the level state. When the next sheet S is discharged, as indicated by a dotted line in FIG. 6C, the stack tray 41 waits for the sheet S with the other end thereof lifted to the position of the sensor 45. The discharged sheet S slides on the upper surface of the inclined stack tray 41 and hits against the stoppers 42. The same operation is repeated. When the sheets S stacked on the stack tray 41 increase, as shown in FIG. 6D, the angle of inclination of the stack tray 41 decreases. Therefore, the top surface of the stacked sheets S does not exceed the position of the sensor 45.

When the sheets S are further discharged and, as shown in FIG. 6E, the top surface of the sheets S stacked on the level stack tray 41 reaches the position of the sensor 45, the image forming apparatus 10 displays, on the display section 142, an indication that the stack tray 41 is full to warn the user to that effect and urges the user to take out the sheets S. As shown in FIGS. 6A to 6E, the stack tray 41 is swung according to the discharge of the sheets S, possible to hit the sheets S against the stoppers 42 and align the sheets S.

The sensor 45 also plays a role of regulating, when no sheet is stacked on the stack tray 41, the angle of inclination of the stack tray 41 within the angle α set in advance and regulating, when the sheets S are stacked on the stack tray 41, the top surface of the stacked sheets S from exceeding the height set in advance and detecting that the stack tray 41 is full.

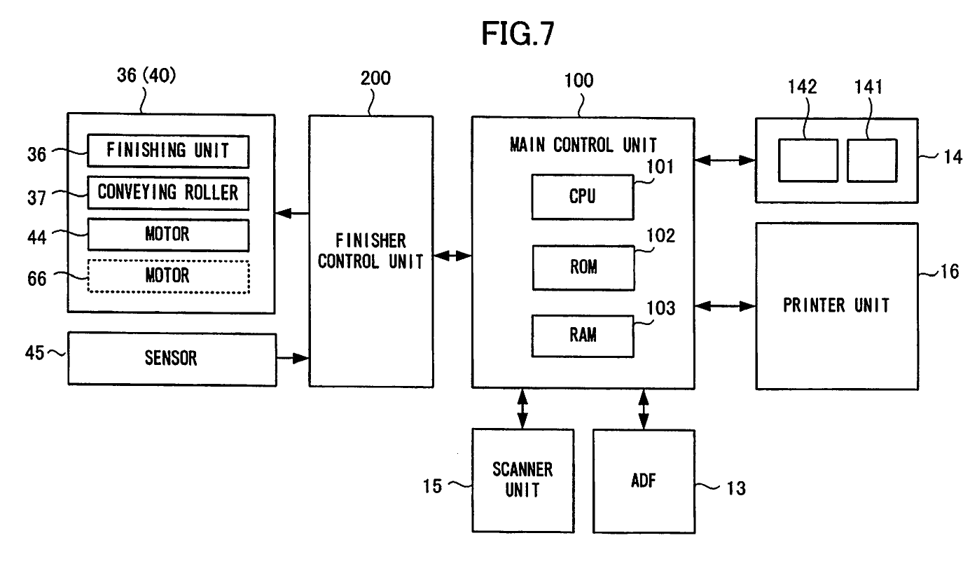

FIG. 7 is a block diagram of a control system for the image forming apparatus 10 and the finisher 36. In FIG. 7, a main control unit 100 includes a CPU 101, a ROM 102, and a RAM 103. The CPU 101 controls the image forming apparatus 10 according to a control program stored in the ROM 102. The main control unit 100 controls the operation of the ADF 13, the scanner unit 15, and the printer unit 16 in response to the operation of the operation panel 14. The RAM 103 temporarily stores control data and is used for arithmetic operation work during the control.

The operation panel 14 includes the plural keys 141 and the display section 142 also serving as a touch panel. The user can give various instructions for image formation to the image forming apparatus 10 through the operation panel 14. For example, the user instructs the number of copies using the keys 141 and instructs a sheet size, a sheet type, punching, stapling, and the like by operating the touch panel of the display section 142.

A finisher control unit 200 controls the operation of the finisher 35 and the operation for sheet discharge. The finisher control unit 200 is connected to the main control unit 100 and exchanges information with the main control unit 100. The image forming apparatus 10 and the finisher 35 operate in cooperation with each other.

The finisher control unit 200 controls a finishing unit (e.g., the puncher 36). The finisher control unit 200 also controls the conveying roller 37 and the motor 44 configured to rotate the stack tray 41. On and off information of the sensor 45 is transmitted to the finisher control unit 200. The finisher control unit 200 detects whether the stack tray 41 rotates to an upper limit or whether the sheets S are fully stacked on the stack tray 41.

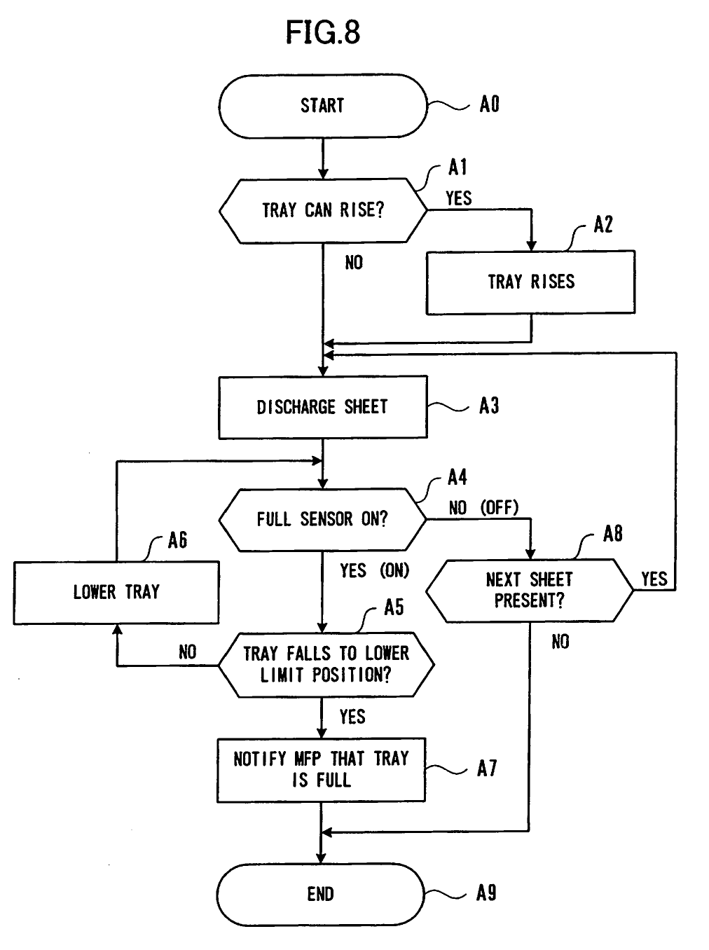

FIG. 8 is a flowchart for explaining the discharging operation for the sheets S shown in FIGS. 5A to 5D. The discharging operation for the sheets S is performed under the control by the finisher control unit 200. In the flowchart of FIG. 8, “tray” means the stack tray 41.

In FIG. 8, start act A0 (Act A0) is a start step for sheet discharge. In Act Al, the finisher control unit 200 determines whether the stack tray 41 can rise. If the tray 41 rotates and rises to the position of the sensor 45, the finisher control unit 200 determines that the stack tray 41 cannot rise and proceeds to Act A3. If the stack tray 41 can rise, the finisher control unit 200 proceeds to Act A2. The stack tray 41 rises.

In Act A3, the finisher control unit 200 discharges the sheets S onto the stack tray 41. In Act A4, the finisher control unit 200 determines whether the sensor 45 is on. Specifically, the finisher control unit 200 determines whether the sheets S are fully stacked on the stack tray 41. If the sensor 45 is on, the finisher control unit 200 proceeds to Act A5 and determines whether the stack tray 41 falls to a lower limit position (the stack tray 41 is level). If the stack tray 41 is not in the lower limit position, the finisher control unit 200 proceeds to Act A6 and lowers the stack tray 41. According to repetition of Acts A4 to A6, as shown in FIGS. 5B and 5C, the stack tray 41 falls stepwise.

If the sensor 45 detects in Act A4 that the stack tray 41 is full and the finisher control unit 200 determines in Act A5 that the stack tray 41 falls to the lower limit position, the finisher control unit 200 proceeds to Act A7. The finisher control unit 200 notifies the image forming apparatus (the MFP) 10 that the sheets S are fully stacked. The finisher control unit 200 proceeds to Act A9 and ends the operation (equivalent to FIG. 5D).

On the other hand, if the sensor 45 is off in Act A4, the finisher control unit 200 proceeds to Act A8 and determines presence or absence of the next sheet S. If the next sheet S is present, the finisher control unit 200 returns to Act A3 and continues the discharge of the sheet S. If the next sheet S is absent, the finisher control unit 200 ends the operation in Act A9.

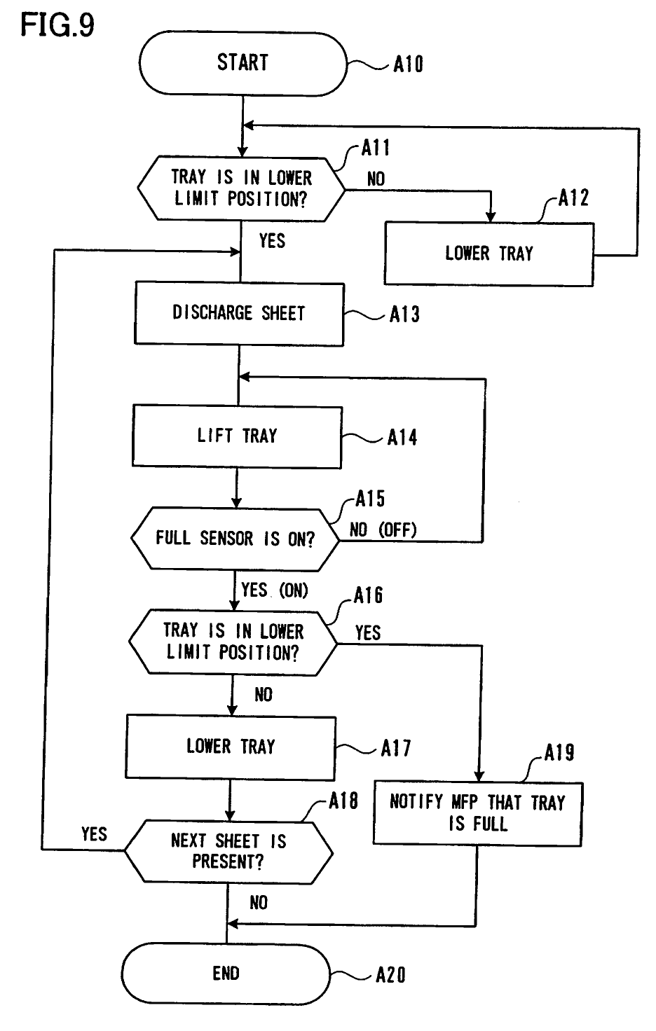

FIG. 9 is a flowchart for explaining the discharging operation for the sheets S shown in FIGS. 6A to 6E. The discharging operation for the sheets S is performed under the control by the finisher control unit 200. In the flowchart of FIG. 9, “tray” means the stack tray 41.

In FIG. 9, start act A10 (Act A10) is a start step for sheet discharge. In Act All, the finisher control unit 200 determines whether the stack tray 41 is in the lower limit position. If the stack tray 41 is not in the lower limit position, the finisher control unit 200 proceeds to Act A12 and rotates and lowers the stack tray 41 to the lower limit position (FIG. 6A).

If the finisher control unit 200 determines in Act All that the stack tray 41 falls, in Act A13, the finisher control unit 200 discharges the sheet S. In the next Act A14, the finisher control unit 200 lifts the stack tray 41. In Act A15, the finisher control unit 200 rotates the stack tray 41 to a position where the sensor 45 is turned on. The stack tray 41 receives the discharged sheet S (FIG. 6B). If the sensor 45 is turned on in Act A15, in Act A16, the finisher control unit 200 determines whether the stack tray 41 is in the lower limit position, i.e., the stack tray 41 is level.

If the stack tray 41 is not in the lower limit position, in Act A17, the finisher control unit 200 lowers the stack tray 41 to the lower limit position. In Act A18, the finisher control unit 200 determines whether the next sheet S is present. If the next sheet S is present, the finisher control unit 200 returns to Act A13 and continues the discharge of the sheet S. If the next sheet S is absent, the finisher control unit 200 ends the operation in Act A20. By repeating Acts A13 to A18, as shown in FIGS. 6B to 6E, possible to stack the sheets S on the stack tray 41 while swinging the stack tray 41 to align the sheets S.

If the sensor 45 detects in Act A15 that the stack tray 41 is full and the finisher control unit 200 determines in Act A16 that the stack tray 41 is in the lower limit position, the finisher control unit 200 proceeds to Act A19. The finisher control unit 200 notifies the image forming apparatus (the MFP) 10 that the sheets are fully stacked. The finisher control unit 200 proceeds to Act A20 and ends the operation (equivalent to FIG. 6E).

A second embodiment is explained below.

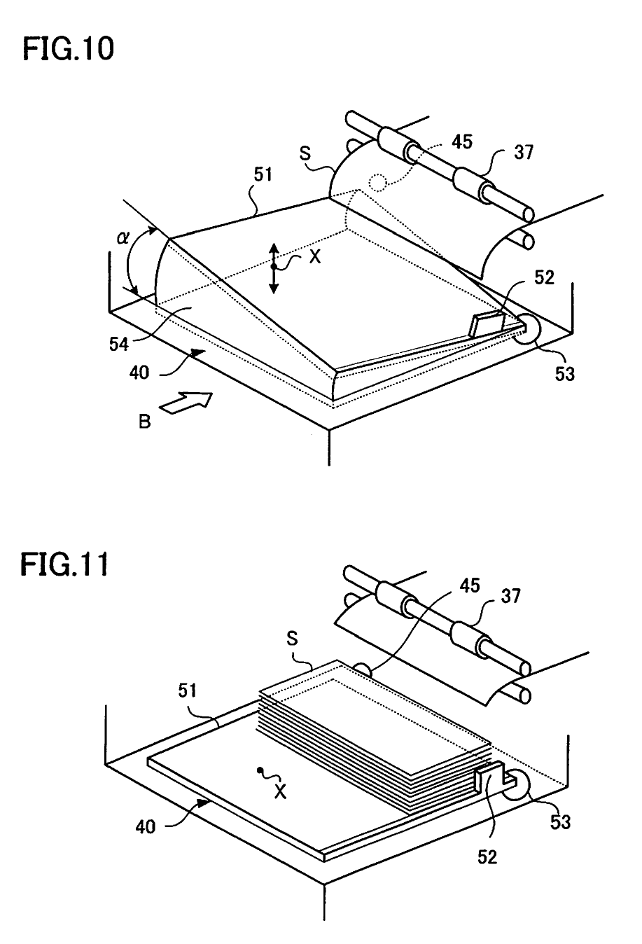

FIG. 10 is a perspective view of the configuration of the sheet discharging unit 40 according to the second embodiment. FIG. 11 is a perspective view for explaining the operation of the sheet discharging unit 40.

The sheet discharging unit 40 is provided downstream of the finisher 35. The sheet S discharged from the conveying roller 37 is discharged onto a stack tray 51. The stack tray 51 has a stopper 52 on the front surface side thereof viewed from the front. A corner of the stack tray 51 near the stopper 52, i.e., a corner on the front surface side and on an upstream side in a conveying direction of the sheet S is supported by a spherical supporting section 53.

An end (a lifting point X) on a downstream side in the sheet conveying direction of the stack tray 51 and on the inner side of the sheet discharging unit 40 can rise and fall by a predetermined angle (α) with the supporting section 53 as a fulcrum. Therefore, the stack tray 51 is inclined with the supporting section 53 as a fulcrum by lifting and lowering the lifting point X. When the stack tray 51 is inclined, a corner in a diagonal position from the supporting section 53 has a largest angle of inclination.

FIG. 11 is a diagram of a state in which the stack tray 51 is lowered and laid level and the sheets S are stacked on the stacked tray 51. The sensor 45 is attached to the lower part of the conveying roller 37. The sensor 45 detects that the top surface of the sheets S stacked on the stack tray 51 reaches the position of the sensor 45 or the empty stack tray 51 rotates to reach the position of the sensor 45. The sensor 45 controls driving of a motor for lifting and lowering the stack tray 51. The driving control for the motor for lifting and lowering the stack tray 51 is explained later.

When the stack tray 51 is inclined and the sheets S are stacked thereon, the sheets S hit against the stopper 52 provided near the supporting section 53 to be aligned. A cover 54 is provided on a side of the stack tray 51 viewed from an arrow B direction to prevent a finger from being caught. The cover 54 is integrally formed with the stack tray 51 and set in the main body 11.

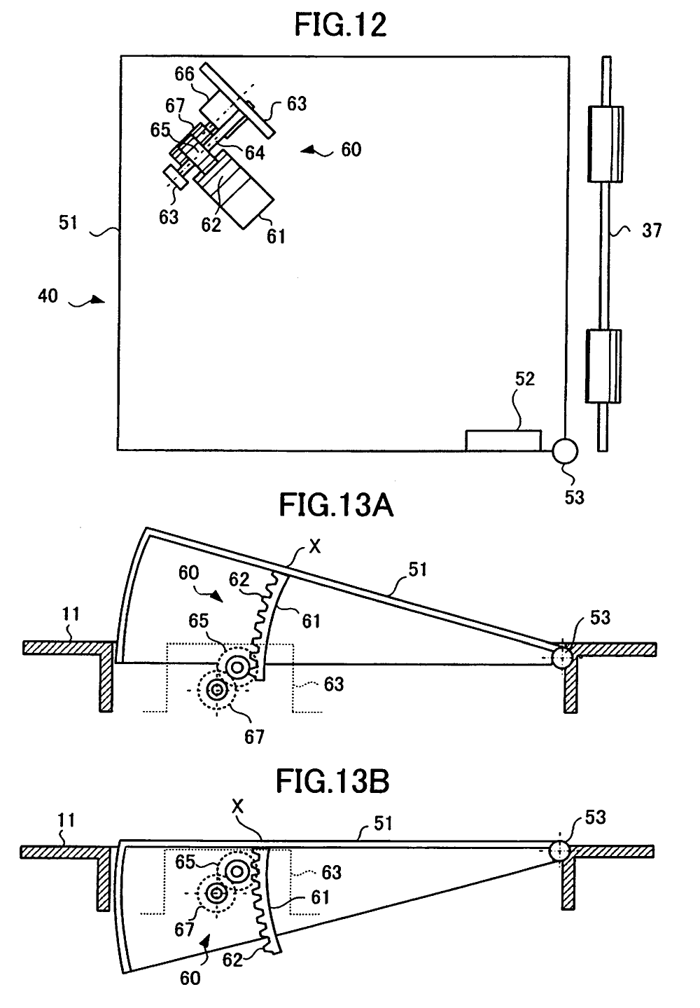

FIG. 12 is a plan view of a lifting and lowering mechanism 60 for lifting and lowering the lifting point X of the stack tray 51. The lifting and lowering mechanism 60 is provided on the bottom of the stack tray 51 and cannot be seen from above hidden behind the stack tray 51. However, in FIG. 12, the stack tray 51 is shown in a transparent manner. FIGS. 13A and 13B are diagrams for explaining lifting and lowering operation by the lifting and lowering mechanism 60.

In the lifting and lowering mechanism 60, a rack 62 is formed in a lifting and lowering member 61 provided on the bottom surface of the stack tray 51. A rotating shaft 64 is attached to an attaching member 63 formed upward from the main body 11. A pinion 65 configured to mesh with the rack 62 is provided in the rotating shaft 64.

A motor 66 is attached to the attaching member 63. The motor 66 drives to rotate a gear 67. The gear 67 meshes with the pinion 65. Therefore, when the motor 66 rotates, the gear 67 and the pinion 65 rotate and the lifting and lowering member 61 is lifted and lowered by the rack 62.

In FIG. 13A, a state in which the motor 66 rotates in a first direction and the lifting and lowering member 61 rises is shown. In FIG. 13B, a state in which the motor 66 rotates in a second direction and the lifting and lowering member 61 falls is shown.

The stack tray 51 is lifted and lowered according to the rotation of the motor 66. In the same manner as the operation shown in FIGS. 5A to 5D, the finisher control unit 200 shown in FIG. 7 can lift and lower the stack tray 51 to stack the sheets S thereon. However, since the stack tray 51 rotates (rises and falls) with the spherical supporting section 53 as a fulcrum, the sheets S slip down to the supporting section 53 and are received and aligned by the stopper 53.

Specifically, in the initial state in which the sheet S is discharged, in the same manner as the operation shown in FIG. 5A, the stack tray 51 rotates to the position of the sensor 45 (the angle α) and waits for the sheet S in an inclined state. When the sheets S are sequentially discharged and stacked on the stack tray 51, in the same manner as the operation shown in FIGS. 5B and 5C, the stack tray 51 rotates in a direction in which the angle of inclination decreases. The top surface of the stacked sheets S does not exceed the position of the sensor 45.

When the sheets S are further discharged and, in the same manner as the operation shown in FIG. 5D, the stack tray 51 lies level and the top surface of the stacked sheets S reaches the position of the sensor 45, the image forming apparatus 10 displays, on the display section 142, an indication that the stack tray 51 is full to warn a user to that effect and urges the user to take out the sheets S.

In the same manner as the operation shown in FIGS. 6A to 6E, the discharging operation for the sheets S may be performed. Specifically, in the same manner as the operation shown in FIG. 6A, in the initial state in which the sheet S is discharged, the stack tray 51 is set in a level state. When the sheet S is discharged, in the same manner as the operation shown in FIG. 6B, the stack tray 51 rotates to the position of the sensor 45 (the angle α). The sheet S slides on the upper surface of the inclined stack tray 51 and hits against the stopper 52. Thereafter, in the same manner as the operation shown in FIGS. 6C and 6D, the stack tray 51 is lifted and lowered according to the discharge of the sheet S. The angle of inclination of the stack tray. 51 is gradually reduced as the sheets S stacked on the stack tray 51 increase. When the sheets S are discharged and, in the same manner as the operation shown in FIG. 6E, the top surface of the sheets S stacked on the level stack tray 51 reaches the position of the sensor 45, the image forming apparatus 10 displays, on the display section 142, an indication that the stack tray 51 is full to warn the user to that effect and urges the user to take out the sheets.

In the second embodiment, the stack tray 51 is lifted and lowered by the motor 66, therefore, possible to carry out the discharging operation for sheets according to flowcharts same as those of FIGS. 8 and 9.

According to the second embodiment explained above, when the sheets S are discharged to the sheet discharging unit 40, the stack tray 51 is inclined such that the front side thereof viewed from the user is low and the inner side thereof is high. Therefore, the user can easily recognize the discharge of the sheets S and easily take out the sheets S.

Further, not limited to the above-described embodiments, and can be modified into various forms. For example, in the system explained above, the image forming apparatus 10 includes the intermediate transfer belt 19. However, a system not including the intermediate transfer belt 19 may be adopted. In the example explained above, the sheets subjected to finishing by the finisher 35 are discharged to the sheet discharging unit 40. However, the sheets S can also be discharged to the sheet discharging unit 40 without being subjected to finishing.

The image forming apparatus 10 not including the finisher 35 may be adopted. Specifically, the sheet discharged from the conveying roller 34 shown in FIG. 2 may be directly discharged to the sheet discharging unit 40.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a main body incorporating an image forming unit configured to form an image on a sheet;
a document reading unit arranged above the main body;
a sheet discharging unit provided in a space between the document reading unit and the image forming unit;
a conveying unit configured to convey the sheet to the sheet discharging unit;
a stack tray on which the sheet discharged to the sheet discharging unit is stacked;
a rotating mechanism configured to lift and lower, with a front surface side of the stack tray as a fulcrum, the other end of the stack tray to incline the stack tray; and
a control unit configured to control an angle of inclination of the stack tray in association with the discharge of the sheet such that the angle of inclination decreases as sheets stacked on the stack tray increase.

2. The apparatus of claim 1, wherein the stack tray has a stopper at an end on the front surface side and hits the sheet stacked on the stack tray against the stopper to align the sheet.

3. The apparatus of claim 1, wherein the rotating mechanism includes:
a supporting shaft provided on a front surface side of the sheet discharging unit and configured to support the front surface side of the stack tray; and
a first motor configured to drive to rotate the supporting shaft.

4. The apparatus of claim 1, wherein the rotating mechanism includes:
a supporting section configured to support a corner of the stack tray on the front surface side of the sheet discharging unit and on an upstream side in a conveying direction of the sheet;
a lifting and lowering mechanism configured to lift and lower a corner of the stack tray in a diagonal position from the supporting section; and
a second motor configured to drive the lifting and lowering mechanism.

5. The apparatus of claim 4, wherein the lifting and lowering mechanism includes a rack attached to a lower part of the stack tray, a pinion configured to mesh with the rack, and a gear configured to mesh with the pinion and drives to rotate the gear with the second motor.

6. The apparatus of claim 1, wherein
a sensor is provided in a height position set in advance of the sheet discharging unit, and
the control unit inclines the stack tray to the sensor position in a state in which the sheet is not discharged, reduces the angle of inclination as sheets stacked on the stack tray increase, and notifies, when the stack tray lies level and a top surface of the stacked sheets reaches the sensor position, the apparatus that the stack tray is full.

7. The apparatus of claim 1, wherein
a sensor is provided in a height position set in advance of the sheet discharging unit, and
the control unit swings the stack tray between a level state and an inclined state according to the discharge of the sheet, reduces the angle of inclination as sheets stacked on the stack tray increase, and notifies, when the stack tray lies level and a top surface of the stacked sheets reaches the sensor position, the apparatus that the stack tray is full.

8. The apparatus of claim 1, wherein
a finisher is arranged between the document reading unit and the image forming unit,
the sheet discharging unit is provided on a downstream side of the finisher, and
the sheet subjected to finishing by the finisher is placed on the stack tray.

9. A sheet discharging apparatus comprising:
a sheet discharging unit configured to store a sheet discharged from an image forming apparatus or a finisher;
a stack tray on which the sheet discharged to the sheet discharging unit is stacked;
a rotating mechanism configured to lift and lower, with a front surface side of the stack tray as a fulcrum, the other end of the stack tray to incline the stack tray; and
a control unit configured to control an angle of inclination of the stack tray in association with the discharge of the sheet such that the angle of inclination decreases as sheets stacked on the stack tray increase.

10. The apparatus of claim 9, wherein the stack tray has a stopper at an end on the front surface side and hits the sheet stacked on the stack tray against the stopper to align the sheet.

11. The apparatus of claim 9, wherein the rotating mechanism includes:
a supporting shaft provided on a front surface side of the sheet discharging unit and configured to support the front surface side of the stack tray; and
a first motor configured to drive to rotate the supporting shaft.

12. The apparatus of claim 9, wherein the rotating mechanism includes:
a supporting section configured to support a corner of the stack tray on the front surface side of the sheet discharging unit and on an upstream side in a conveying direction of the sheet;
a lifting and lowering mechanism configured to lift and lower a corner of the stack tray in a diagonal position from the supporting section; and
a second motor configured to drive the lifting and lowering mechanism.

13. The apparatus of claim 10, wherein
a sensor is provided in a height position set in advance of the sheet discharging unit, and
the control unit inclines the stack tray to the sensor position in a state in which the sheet is not discharged, reduces the angle of inclination as sheets stacked on the stack tray increase, and notifies, when the stack tray lies level and a top surface of the stacked sheets reaches the sensor position, the apparatus that the stack tray is full.

14. The apparatus of claim 10, wherein
a sensor is provided in a height position set in advance of the sheet discharging unit, and
the control unit swings the stack tray between a level state and an inclined state according to the discharge of the sheet, reduces the angle of inclination as sheets stacked on the stack tray increase, and notifies, when the stack tray lies level and a top surface of the stacked sheets reaches the sensor position, the apparatus that the stack tray is full.

15. A sheet discharging method comprising:
stacking, on a stack tray, a sheet discharged from an image forming apparatus or a finisher;
lifting and lowering, with a front surface side of the stack tray as a fulcrum, the other end of the stack tray to enable the stack tray to incline; and
controlling an angle of inclination of the stack tray in association with the discharge of the sheet such that the angle of inclination decreases as sheets stacked on the stack tray increase.

16. The method of claim 15, wherein
the stack tray has a stopper at an end on the front surface side, and P1 the method further comprises hitting the sheet stacked on the stack tray against the stopper to align the sheet.

17. The method of claim 15, wherein
an end on the front surface side of the stack tray is supported by a supporting shaft, and
the method further comprising driving to rotate the supporting shaft with a first motor to incline the stack tray.

18. The method of claim 15, wherein
a corner of the stack tray on the front surface side and on an upstream side in a conveying direction of the sheet is supported by a supporting section, and
the method further comprises lifting and lowering a corner of the stack tray in a diagonal position from the supporting section with a second motor to incline the stack tray.

19. The method of claim 16, wherein
a sensor is provided in a position higher than a surface of the stack tray in a level state, and
the method further comprises:
inclining the stack tray to the sensor position in a state in which the sheet is not discharged;
reducing the angle of inclination as sheets stacked on the stack tray increase; and
notifying, when the stack tray lies level and a top surface of the stacked sheets reaches the sensor position, the apparatus that the stack tray is full.

20. The method of claim 16, wherein
a sensor is provided in a position higher than a surface of the stack tray in a level state, and
the method further comprises:
swinging the stack tray between the level state and an inclined state according to the discharge of the sheet;
reducing the angle of inclination as sheets stacked on the stack tray increase; and
notifying, when the stack tray lies level and a top surface of the stacked sheets reaches the sensor position, the apparatus that the stack tray is full.
